(19) United States
(12) Patent Application Publication
(10) Pub. No.: US 2011/0315075 A1
(43) Pub. Date: Dec. 29, 2011

(54) APPLICATION APPARATUS AND METHOD

(75) Inventor: Hiroki Yamamoto, Kagawa (JP)

(73) Assignee: UNICHARM CORPORATION, Ehime (JP)

(21) Appl. No.: 12/743,931

(22) PCT Filed: Mar. 2, 2010
(86) PCT No.: PCT/JP2010/053741

§ 371 Date: Jul. 5, 2011

(30) Foreign Application Priority Data
Mar. 2, 2009 (JP) 2009-048651

(51) Int. Cl. B05C 1/08

(52) U.S. Cl. 118/262

(57) ABSTRACT

A web (200) passing a second press roll (105) while being held between an application roll (103) and the second press roll (105) is conveyed in such a manner that the web (200) is inclined toward the second press roll (105) from a tangent line (1) at a point of contact between the application roll (103) and the second press roll (105). A rotation speed (V1) of a first press roll (104) is equal to a conveyance speed (V_{MD}) of the web (200). A rotation speed (V2) of the second press roll (105) is equal to the conveyance speed (V_{MD}) of the web (200). A rotation speed (V3) of a feed roll (106) is higher than the conveyance speed (V_{MD}) of the web (200).

### TECHNICAL FIELD

The present disclosure relates to an application apparatus and an application method which apply a liquid or liquefied or fluidic material, such as an adhesive agent or a pigment, to a continuous web.

### BACKGROUND ART

An absorbent article such as a disposable pants-type diaper mainly includes a liquid-permeable top sheet, a bottom sheet, and an absorber.

The top sheet is adapted to come into contact with the skin of a wearer of the absorbent article. The bottom sheet is provided outside the top sheet. The absorber is provided between the top sheet and the bottom sheet for absorbing excretion from the wearer.

The top sheet, the bottom sheet, and the absorber are bonded with each other with an adhesive agent. Some disposable diapers for infants include various patterns which are printed on an inner or outer surface of the bottom sheet.

There is a known application apparatus in which a material, such as an adhesive agent or a pigment melt by heat, is transferred onto a transfer roll through a roll coater, and then the material transferred to the transfer roll is transferred to a web such as a nonwoven fabric (see, for example, Patent Literature 1).

The inventors have discovered that a liquid-impermeable sheet such as a bottom sheet may be deformed or broken by the heat of the material melt by heat because the sheet has thereto-plasticity.

Moreover, under certain conditions of viscosity of the adhesive (or melt pigment), strength of the sheet, or a conveyance speed of the web, the material to be transferred to the sheet may remain sticking to a roll, and thus the sheet becomes entangled with the roll. As a result, defective products are produced.

### CITATION LIST

### Patent Literature

PTL 1: Japanese Patent Application Publication No. 2001-157691 (p. 3, FIG. 4)

### SUMMARY

In a first aspect of the present invention, an application apparatus for applying a material to a continuous web being conveyed in a conveyance direction, comprises: an application roll configured to receive the material and apply the received material to the web; and press rolls provided on an opposite side of the web to the application roll and configured to press the web against the application roll. The press rolls include a first press roll which is provided on an upstream side and a second press roll which is provided on a downstream side of the application roll in the conveyance direction of the web.

In a second aspect of the present invention, an application method of applying a material to a continuous web being conveyed in a conveyance direction, comprises: receiving the material on an application roll; and applying the received material from the application roll onto the web, while pressing the web against the application roll by press rolls provided on an opposite side of the web to the application roll. The press rolls include a first press roll which is provided on an upstream side and a second press roll which is provided on a downstream side of the application roll in the conveyance direction of the web.

### BRIEF DESCRIPTION OF DRAWINGS

FIG. 1 is a partially cutaway, perspective view of an absorbent article according to one or more embodiments.

FIG. 2 is a diagram for illustrating a method of manufacturing an absorbent article according to one or more embodiments.

FIG. 3 is a perspective view of an application apparatus for manufacturing an absorbent article according to one or more embodiments.

FIG. 4 is a side view of the application apparatus of FIG. 3 as seen along a rotation axis of a first press roll of the apparatus.

FIG. 5 is a block diagram of the application apparatus.

### DETAILED DESCRIPTION

Hereinafter, a method of and an apparatus for manufacturing an absorbent article, according to one or more embodiments of the present invention, will be described with reference to the drawings.

Note that, in the following description of the drawings, same or similar reference signs denote same or similar elements and portions. In addition, it should be noted that the drawings are schematic and are not to scale unless otherwise specified. Therefore, specific dimensions and the like should be determined in consideration of the following description. Moreover, the drawings do not necessarily reflect the real-life dimensional relationships and ratios of components.

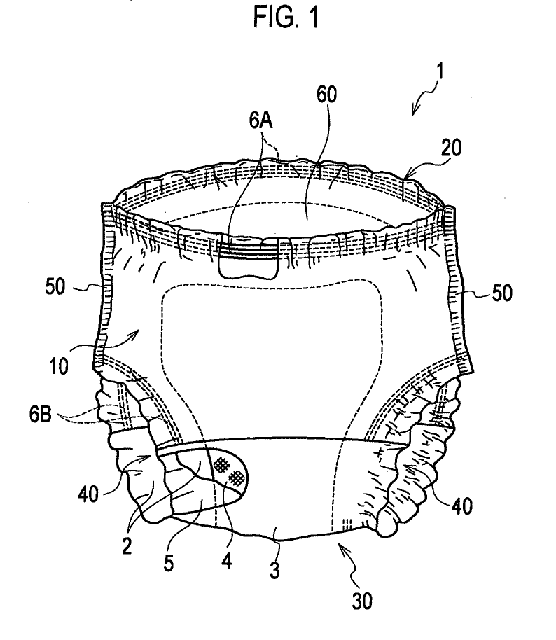

First, a structure of an absorbent article 1 according to one or more embodiments will be described with reference to FIG. 1 which is a partially cut-away perspective view showing the absorbent article 1. In the particularly illustrated embodiment, the absorbent article 1 is a pants-type disposal diaper for adults.

As shown in FIG. 1, the absorbent article 1 is formed mainly of a top sheet 2, a back sheet 3, an absorber 4, and a waterproof sheet 5.

The top sheet 2 is configured to come into contact with a skin of a person wearing the absorbent article 1 (hereinafter, referred to as “wearer”). As the top sheet 2, a liquid-permeable sheet, such as a non-woven fabric or a perforated plastic film, is used.

The back sheet 3 is provided outside the top sheet 2, in other words, the back sheet is provided at the side farther from the wearer than top sheet 2. As the back sheet 3, a non-woven fabric or the like is used.

The absorber 4 is provided between the top sheet 2 and the back sheet 3, and is configured to absorb excretion of the wearer. As the absorber 4, a mixture of comminuted wood pulp and superabsorbent polymer particles, or the like, is used.

The waterproof sheet 5 is provided between the back sheet 3 and the absorber 4, and does not allow excretion of the wearer to permeate therethrough.

The absorbent article 1 as described above is formed by combining: a front waistline portion 10 to be fitted to the front waist of the wearer; a back waistline portion 20 to be fitted to the back waist of the wearer; and the crotch portion 30 to be fitted to the crotch of the wearer.

Note that, leg-surrounding openings 40 are formed respectively at sides of the crotch portion 30, and the legs of the wearer are to be inserted through the leg-surrounding openings 40.

The front waistline portion 10 and the back waistline portion 20 are united by joint portions 50, and thus form a waistline opening 60 to be fit around the body of the wearer.

A waist gather 6A made of rubber strands or the like having stretchability is provided in the peripheral edges of the front waistline portion 10 and the back waistline portion 20.

For example, the front waistline portion 10 and the back waistline portion 20 may be provided with the waist gather 6A to be thus stretchable in a cross direction crossing a front-to-back direction extending from the front waistline portion 10 to the back waistline portion 20, or may themselves be formed of sheets having stretchability to be thus stretchable in the cross direction.

The crotch portion 30 is provided between the front waistline portion 10 and the back waistline portion 20.

Leg gathers 6B each made of rubber strands or the like having stretchability are provided respectively at the sides of the crotch portion 30.

For example, the crotch portion 30 may be provided with the leg gathers 6B to be thus stretchable in the front-to-back direction of the absorbent article 1, or may itself be formed of a sheet having stretchability to be thus stretchable in the front-to-back direction of the absorbent article 1.

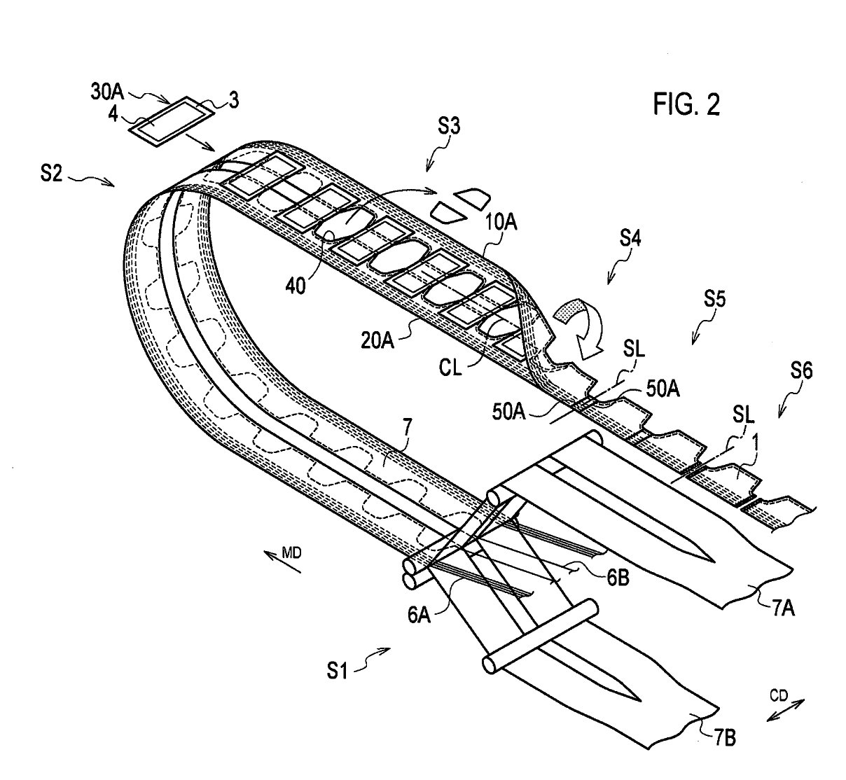

Next, a method of manufacturing an absorbent article 1 according to one or more embodiments will be described with reference to FIG. 2 which is an explanatory view for explaining a relevant part of the absorbent article manufacturing method.

As shown in FIG. 2, the method of manufacturing the absorbent article 1 includes at least a waistline forming step S1, an absorber transferring step S2, a leg-surrounding opening forming step S3, a folding step S4, a joining step S5, and a cutting step S6.

In the waistline forming step S1, a web 7 is formed by disposing gathers (the waist gather 6A and/or the leg gathers 6B) between a web 7A and a web 75. The web 7 is to be processed into the front waistline portion 10 and the back waistline portion 20.

Note that, the web 7 (the webs 7A and 7B) being conveyed is stretchable in a cross direction CD (a width direction) orthogonal to a conveyance direction MD (Machine Direction) of the web 7.

In addition, the web 7 is asymmetrical with respect to a center line CL that bisects a width in the cross direction CD of the web 7 and extends in the conveyance direction MD of the web 7.

In the absorber transferring step S2, a crotch portion member 30A to be processed into the crotch portion 30 is transferred onto the web 7, specifically, between the front waistline portion 10 and the back waistline portion 20, after the waistline forming step S1. Note that, the crotch portion member 30A is formed of the back sheet 3 and the absorber 4.

In the leg-surrounding opening forming step S3, the leg-surrounding openings 40 (so-called leg holes) are formed by cutting the web 7 (the webs 7A and 7B) after the absorber transferring step S2.

Note that, the leg-surrounding openings 40 are not necessarily formed by cutting only the web 7 (the webs 7A and 7B), but may alternatively be formed by cutting the back sheet 3 forming the crotch portion member 30A together with the web 7A and the web 7B.

Here, the absorber transferring step S2 and the leg-surrounding opening forming step S3 may be performed in the reverse order.

In the folding step S4, the web 7 is folded in half along a folding line extending in the conveyance direction MD of the web 7, by bringing a side edge 10A of the front waistline portion 10 in the web 7 toward a side edge 20A of the back waistline portion 20 in the web 7, after the leg-surrounding opening forming step S3.

Note that, in the particularly illustrated embodiment, the folding line is the same as the center line CL. Moreover, the folding line does not necessarily coincide with the center line CL, and may be offset from the center line CL toward the side edge 10A or toward the side edge 20A.

In the joining step S5, the folded parts of the web 7 are joined at joint regions 50A to be processed into the joint portions 50 of the absorbent article 1 by an ultrasonic treatment or a heat treatment, after the folding step S4.

Note that the joint regions 50A respectively indicate regions at both sides of an imaginary line SL in the conveyance direction ND. The imaginary line SL indicates a cutting line extending in the width direction CD.

In the cutting step S6, the web 7 in which the joint regions 50A have been joined is cut along the imaginary line SL after the joining step S5. As a result, the absorbent article 1 is manufactured.

In the waistline forming step S1, the web 7A and the web 7B are overlaid one upon another, sandwiching the waist gathers 6A and/or the leg gathers 6B therebetween. Then, the web 7A and the web 7B are joined to each other with adhesive or the like.

In addition, in the absorber transferring step S2, the crotch portion member 30A transferred onto the web 7 (the web formed of the overlaid webs 7B and 7A) having the leg-surrounding openings 40 formed therein is joined to the web 7 with adhesive or the like.

The crotch member 30A includes the bottom sheet 3 and the absorber 4. Although not illustrated in FIG. 2, the waterproof sheet 5 is provided between the bottom sheet 3 and the absorber 4. The bottom sheet 3 and the absorber 4 are bonded with each other with an adhesive or the like. Similarly, the absorber 4 and the waterproof sheet 5 are jointed with each other with an adhesive or the like.

Note that some products include the waterproof sheet 5 having patterns such as characters on an inner surface and the like of the waterproof sheet 5. In such products, a pigment for drawing the patterns sometimes serves as an adhesive at the same time.

An application apparatus 100, described below, which applies materials such as an adhesive agent or a pigment can be used in a waistline forming step S1, an absorber transferring step S2, and a step of forming a web 7B by disposing a plurality of sheets and the like in FIG. 2.

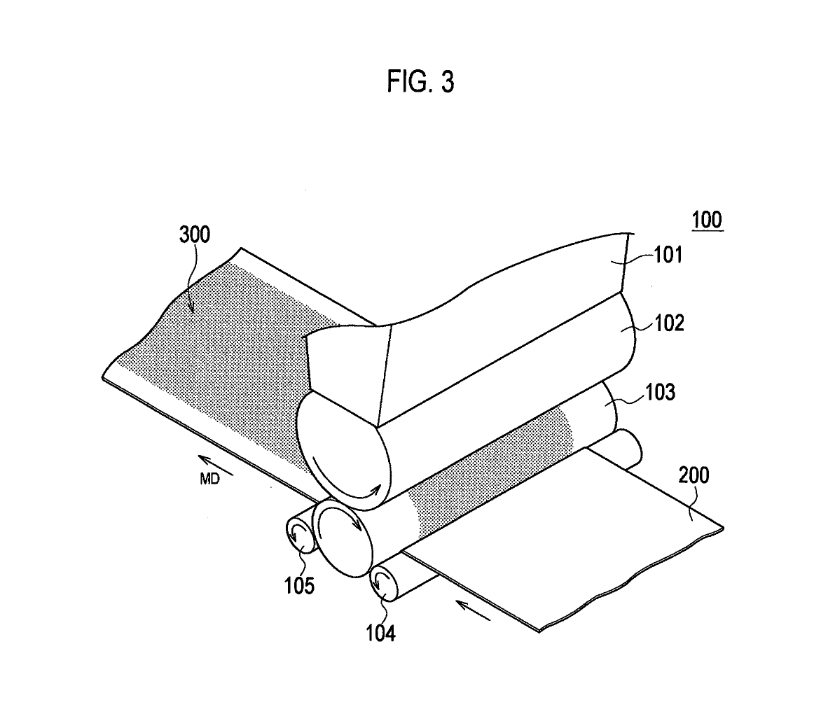

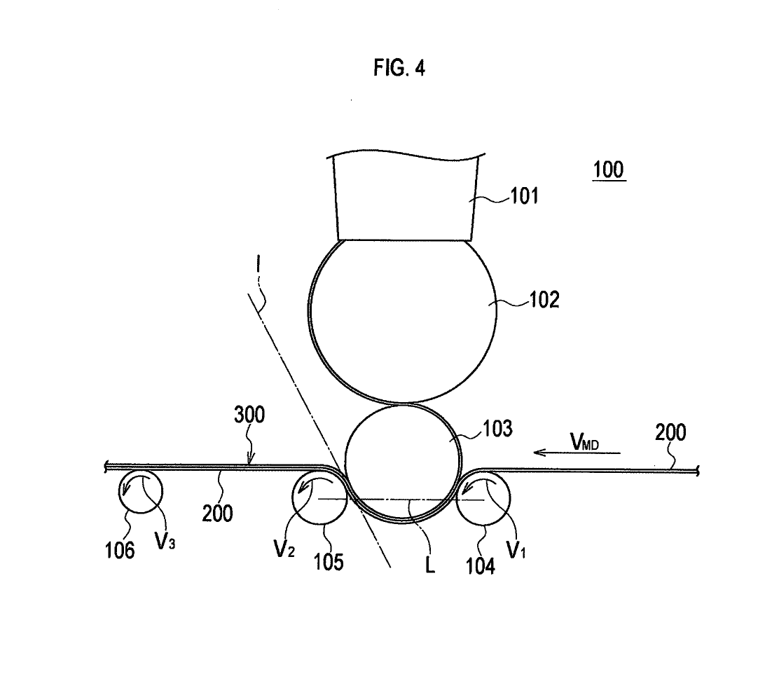

FIG. 3 is a perspective view of an application apparatus 100 according to one or more embodiments. The application apparatus 100 includes a handover roll 102, an application roll 103, a first press roll 104, a second press roll 105 and a feed roll 106 (see FIG. 4).

The handover roll 102 is configured to receive a material from a storage 101 in which the material is stored. The material is transferred to the surface of the handover roll 102 from the storage 101. The handover roll 102 is provided adjacent to the application roll 103 and is configured to transfer the received material to the application roll 103.

The handover roll 102, for example, is a gravure coater on which concave-convex surface is formed.

The application roll 103 is provided adjacent to the handover roll 102. The application roll 103 is configured to receive the material from the handover roll 102.

The application roll 103 has a cooling mechanism which performs control so that the temperature of the material should be lower than that at the time when the handover roll 102 receives the material from the storage unit 101.

Then, the application roll 103 is configured to apply the received material to the web 200. The web 200 is equivalent to, for example, the sheet constituting the crotch member 30A or the web 7B.

The first press roll 104 and the second press roll 105 are provided on the opposite side of the web 200 to the application roll 103. The first press roll 104 is positioned on the upstream side while the second press roll 105 is positioned on the downstream side of the application roll 103 in the conveyance direction of the web 200.

The first press roll 104 and the second press roll 105 are configured to press the web 200 against the application roll 103.

The second press roll 105 is provided downstream of the first press roll 104 in the conveyance direction MD of the web 200.

The feed roll 106 is provided downstream of the second press roll 105 in the conveyance direction MD of the web 200.

In the above-described application apparatus 100, the first press roll 104 and the second press roll 105 are configured to press the web 200 against the application roll 103.

The web 200 is conveyed in the conveyance direction MD in the state where the web winds around one portion of the outer circumference of the application roll 103.

While the web 200 winds around the one portion of the application roll 103, the material is transferred from the application roll 103 to the web 200. Thus, an applied region 300 where the material is applied to the web is formed on the surface of the web 20.

FIG. 4 is a side view seen along the rotation axis direction of the first press roll 104 and the second press roll 105.

As shown in FIG. 4, a tangent line at a point of contact between the application roll 103 and the second press roll 105 is “l”.

The application apparatus 100 is configured to convey the web 200 in such a manner that the web 200 is inclined toward the second press roll 105 from the tangent line 1, the web 200 passing the second press roll 105 while being held between the application roll 103 and the second press roll 105.

In other words, the conveyance direction MD of the web 200 after the material is applied does not overlap with the tangent line l.

Additionally, as shown in FIG. 4, an imaginary line L connecting the rotation axis of the first press roll 104 and the rotation axis of the second press roll 105 intersects the outer circumferential line of the application roll 103.

In FIG. 4, a rotation speed V1 of the first press roll 104 is equal to a conveyance speed V_{MD} of the web 200 upstream of the first press roll 104.

A rotation speed V2 of the second press roll 105 is equal to the conveyance speed V_{MD} of the web 200.

A rotation speed V3 of the feed roll 106 is higher than the conveyance velocity V_{MD} of the web 200.

Although it is not shown in FIG. 4, a driving roll which drives the web 200 at the speed V_{MD} is provided downstream of the feed roll 106.

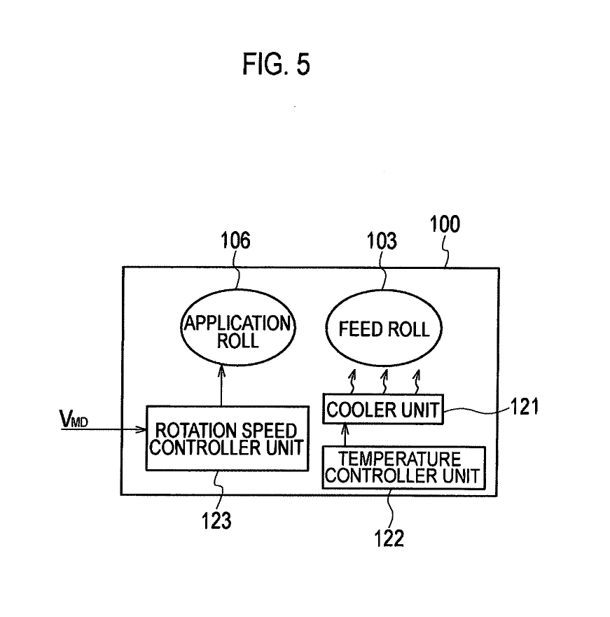

FIG. 5 is a block diagram of the application apparatus 100.

The application apparatus 100 includes a cooler unit 121 configured to cool the application roll 103, and a temperature controller unit 122 configured to control a temperature of the cooler unit 121.

Moreover, the application apparatus 100 includes a rotation speed controller unit 123 configured to detect the conveyance speed V_{MD} and to perform control so that the rotation speed V3 of the feed roll 106 should be higher than the conveyance speed V_{MD} of the web 200.

According to the above configuration, the application roll 103 is configured to set the temperature of the material lower than that at the time when the handover roll 102 receives the material from the storage unit 101.

The application roll 103 is configured to apply the material at the lowered temperature to the web 200.

In other words, in the embodiment, the cooler unit 121 and the temperature controller unit 122 constitute a cooling mechanism.

In the embodiment, a melting point of the material is approximately 40° C. The application has. coatable viscosity in an application temperature from 65° C. to 150° C.

The temperature of the cooling mechanism is higher than the melting point, and is at least 5° C. lower than the application temperature.

As described above, since the web 200 is pressed by the first press roll 104 and the second press roll 105 against the application roll 103, the web 200 can receive the material securely from the application roll 103.

Also, the application apparatus 100 according to one or more embodiments conveys the web 200 in such a manner that the web 200 is inclined toward the second press roll 105 from the tangent line 1 at the point of contact between the application roll 103 and the second press roll 105, the web 200 passing the second press roll 105 while being held between the application roll 103 and the second press roll 105.

This enables the web 200 to securely receive the material from the application roller 103, and prevents the web 200 after the application of the material from sticking to the application roll 103 and winding around the application roll 103.

In addition, the imaginary line L connecting between the rotation axis of the first press roll 104 and the rotation axis of the second press roll 105 intersects the outer circumferential line of the application roll 103.

Thus, the web 200 is securely pressed against one portion of the circumference of the application roll 103, so that the web 200 can securely receive the material from the application roll 103.

In the application apparatus 100, since the rotation speed V3 of the feed roll 106 is controlled so as to be higher than the conveyance speed V_{MD} of the web 200, the web 200 is stretched in the conveyance direction. Accordingly, the web 200 can securely come off the application roll 103, without sticking to the application roll 103 and winding around the application roll 103.

In addition, the application apparatus 100 includes the cooling mechanism. The cooling mechanism adjusts a temperature of the material, while maintaining its liquidity, such that the material is applicable to the web 200 at the adjusted temperature.

Accordingly, the web 200 can be prevented from being deformed or broken by the heat of the material. Thus, the defective products produced when the material is applied at high temperature can be prevented, so that a yield in production can be increased.

As described above, the details of several embodiments of the present invention have been exemplarily disclosed. It should not be understood that the description and drawings which constitute part of this disclosure limit the present invention. Based on this disclosure, those skilled in the art may easily come up with various alternative embodiments, examples and operation techniques.

For example, following additional embodiments can be envisaged.

Specifically, one or more embodiments are applicable to the case where a material other than an adhesive or a pigment is applied by the application apparatus.

The material may be an ink for printing patterns such as decorative characters on wearing articles, or an indicator which changes color and/or other visual properties to indicate when the article (e.g., a diaper) needs to be exchanged.

In addition, one or more embodiments are applicable not only to a step of bonding sheets with each other or bonding a sheet with an absorber, but also to a step of applying drugs, lotions, or the like to a skin-contactable surface of at least a portion of the wearing article, e.g., a crotch member 30A.

In addition, the method of manufacturing absorbent articles is not limited to the manufacturing of disposable diapers, but may be used for manufacturing, for example, sanitary napkins, panty liners, or articles other than absorbent articles.

In the foregoing description, a cooling mechanism e.g., the cooler unit 121, cools the application roll 103. However, the cooling mechanism may be provided in the first press roll 104 and/or the second press roll 105.

Alternatively, the cooling mechanism may be provided in any one or all of the application roll 103, the first press roll 104, and the second press roll 105.

In this case, the temperature of the material can be more effectively decreased than in the case where the cooling mechanism only cools the application roll 103.

Accordingly, the temperature of the material can be adjusted to a temperature at which the material is applicable to the web 200. Consequently, the web 200 is prevented from being deformed or broken by the heat of the material.

As described above, the present invention naturally includes various embodiments which are not described herein. Accordingly, the technical scope of the present invention should be determined only by the matters to define the invention in the scope of claims regarded as appropriate based on the description.

The entire content of Japanese Patent Application 2009-048651 (filed on Mar. 2, 2009) is incorporated herein by reference.

### INDUSTRIAL APPLICABILITY

Therefore, according to the present invention, it is possible to provide an application apparatus capable of preventing products from being defective when a liquid material such as an adhesive or a pigment is applied to a continuous web, and whereby capable of preventing a yield in production from decreasing.

### REFERENCE SIGNS LIST

1 absorbent article
2 top surface sheet
3 bottom surface sheet
4 absorber
5 waterproof sheet
6 gather
6A waist gather
6B leg gather
7A, 7B web
10 front waistline portion
20 back waistline portion
30 crotch portion
40 leg-surrounding openings
50 joint portions
60 waistline openings
100 application device
101 storage
102 handover roll
103 application roll
104 first press roll
105 second press roll
106 feed roll
121 cooler
122 temperature controller
123 rotation speed controller
200 web
300 applied region

1. An application apparatus configured to apply an application material to a continuous web being conveyed, comprising:
a handover roll configured to receive the application material from a storage unit configured to store the application material;
an application roll provided adjacent to the handover roll and configured to receive the application material from the handover roll and apply the received application material to the web; and
press rolls provided on an opposite side of the web to the application roll and configured to press down the web to the application roll, wherein
the press rolls include a first press roll and a second press roll which is provided downstream of the first press roll in a conveyance direction of the web, and
in a plan view seen from a rotation axis direction of the first press roll and the second roll, the web passing the second press roll while being held between the application roll and the second press roll is conveyed in such a manner that the web is inclined toward the second press roll from a tangent line at a point of contact between the application roll and the second press roll.

2. The application apparatus according to claim 1, wherein, in the plan view seen from the rotation axis direction of the first press roll and the second press roll, an imaginary line connecting between a rotation axis of the first press roll and a rotation axis of the second press roll intersects an outer circumferential line of the application roll.

3. The application apparatus according to claim 1, further comprising a feed roll provided downstream of the second press roll in the conveyance direction of the web, wherein
a rotation speed of the feed roll is higher than a conveyance speed of the web.

4. The application apparatus according to claim 1, wherein the application roll includes a cooling mechanism configured to set a temperature of the application material to be lower than that at the time when the handover roll receives the application material from the storage.
